(19) United States
(12) Patent Application Publication
(10) Pub. No.: US 2007/0137378 A1
(43) Pub. Date: Jun. 21, 2007

(54) Vehicle steering column arrangement

(75) Inventors: Christian Bastein, Neu-Wulmstorf (DE); Fred Eggers, Buxtehude (DE); Torsten Harms, Hamburg (DE); Holger Kittler, Hamburg (DE); Sven Sagner, Hamburg (DE); Joerk Tatulinski, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/572,322

(22) PCT Filed: Aug. 19, 2004
(86) PCT No.: PCT/EP04/09293

§ 371 Date: Oct. 11, 2006

(30) Foreign Application Priority Data
Sep. 20, 2003 (DE) 103 43 685.5

(51) Int. Cl. B62D 1/18

(52) U.S. Cl. 74/493

(57) ABSTRACT

A vehicle steering column consists of an inner steering column element, an outer steering column element and a sliding bush arranged therebetween. The sliding bush is fixedly connected to the outer steering column element by plastic, which is injection molded into depressions on the outer circumferential surface of the sliding bush.

### BACKGROUND AND SUMMARY OF THE INVENTION

The present invention relates to a vehicle steering column.

Steering column arrangements in vehicles serve in general to make it possible for the height and the length of steering wheels to be displaced, in order to adapt to different anatomies or seat positions of drivers for the purpose of increasing comfort.

In order to make it possible for steering column arrangements of this type to be displaced axially, an inner steering column element is provided which has mounted a steering spindle which is connected to the steering wheel. The inner steering column element is mounted in an outer steering column element, and it is possible for the two steering column elements to be displaced relative to one another, in order to permit the axial displacement in a desired manner.

Here, it is necessarily required that the parts can be displaced relative to one another only with small forces, it not being the intention to influence the overall rigidity of the steering column arrangement. For this purpose, the connection between the inner steering column element and the outer steering column element has to be as free of play as possible, as the operating loads are transmitted mainly via the inner steering column element.

It is already known to provide a sliding bush between these two elements, with the result that one steering column element can slide relative to the other steering column element, the sliding bush also serving to avoid vibrations which are undesirable in the steering wheel.

It is known from the prior art to press the sliding bush onto the inner steering column element or to fasten it thereto permanently by upset forging or by other means. It is made possible for the inner steering column element to slide relative to the sliding bush by the selection of a narrow tolerance between the outer shape of the sliding bush and the inner shape of the outer steering column element, which tolerance is so narrow that the required axial setting can be carried out.

For this purpose, however, the outer steering column element has to have a sufficient length axially parallel with respect to the sliding bush, in order to cover the desired total axial displacement path. This means that the inner steering column element, the outer steering column element and the sliding bush have to be fixed to appropriate dimensional tolerances in an excessively accurate manner, which firstly proves expensive for their manufacture and secondly makes it necessary for the manufacturing tolerances already to be taken into consideration for the later interaction of these three components. For these reasons, axial tilting of the parts with respect to one another, which leads to vibrations, cannot be precluded.

In relation to this, it is known from the prior art, for example from German document DE 199 45 160 A1, to bond the sliding bush adhesively to the outer steering column element. Here, only filling holes are provided in the outer steering column element, with the result that only punctiform connecting locations which reduce the strength are formed between the sliding bush and the outer steering column element.

Proceeding from this, it is an object of the present invention to improve a steering column arrangement in such a way that a reliable, vibration free connection is brought about between the sliding bush and the outer steering column element, it being intended for the manufacturing tolerances to have no influence on the later operation.

This object is achieved with the features claimed.

Accordingly, the vehicle steering column according to the invention has an inner steering column element which accommodates a steering spindle, and an outer steering column element which is arranged radially around an inner steering column element. It is possible for the inner steering column element and the outer steering column element to be displaced with respect to one another by way of a sliding bush which bears slidably against the inner steering column element and is connected captively to the outer steering column element. The sliding bush has at least two depressions, lying radially on the outside, in the form of pockets, which are filled with plastic by injection molding through the outer steering column element, with the formation of a fixed connection between the outer steering column element and the sliding bush.

Here, at least two depressions are provided which are made in opposing ends of the sliding bush, with the result that they are at a maximum possible spacing from one another which precludes the ability to tilt axially. It is also possible for more depressions, for example three, to be provided, with one depression in the center between the two outwardly lying depressions.

In one preferred embodiment of the invention, the sliding bush has a slot over its entire length. Here, the depressions extend circumferentially as far as both sides of the slot.

The sliding bush is under a prestress and has a considerable amount of play with respect to the outer steering column element, to which play the manufacturing tolerances can be added. However, this play is eliminated during manufacture by the injection molding of the plastic, with the result that the inner steering column element can be displaced axially in the sliding bush with minimum play and with low tensile and compressive forces. For this purpose, the sliding bush is composed of a suitable material with sliding properties, in particular of a plastic with low friction properties.

In a further embodiment of the invention, the sliding bush has a plurality of reinforcing ribs between the depressions which lie apart from one another in order to increase the stability of the sliding bush.

For better torque transmission, it is customary for the inner steering column element, the outer steering column element and the sliding bush to be of triangular configuration, such that their shapes are complementary. However, they are advantageously of cylindrical design, which makes simple manufacturing possible.

The refinement according to the invention with a sliding bush which is connected via plastic injection molding to the outer steering column element has the advantage that the components can be made without mechanical machining, and a locating fit is not required between the sliding bush and the outer steering column element. During injection molding of the plastic into the pocketlike depressions, a playfree connection can be established between the outer steering column element and the sliding bush. A connection having sufficient sliding properties is ensured constantly between the sliding bush and the inner steering column element.

Further details of the invention result from the exemplary embodiments which will be described in the following text in conjunction with the appended drawings.

### BRIEF DESCRIPTION OF THE DRAWINGS

FIG. 1 shows a diagrammatic sectional view through a steering column arrangement according to the invention; and

FIG. 2 shows a diagrammatic perspective view of a sliding bush which is used in a steering column arrangement according to the invention.

### DETAILED DESCRIPTION OF THE INVENTION

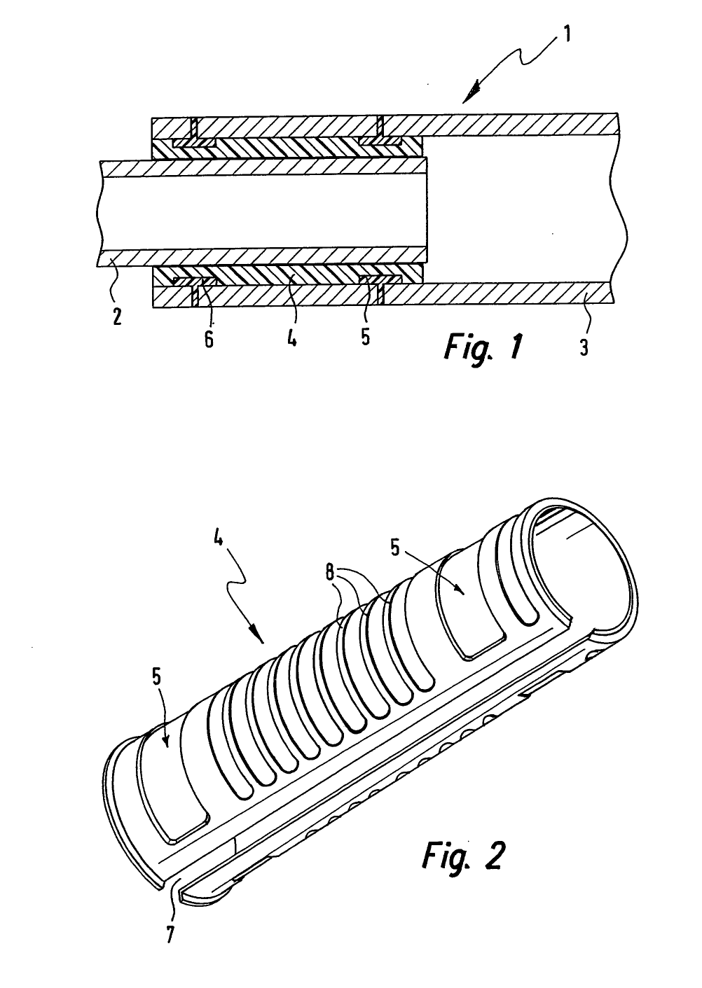

FIG. 1 shows a sectional view of a vehicle steering column according to the invention.

The vehicle steering column 1 has an inner steering column element 2 which accommodates a steering spindle (not shown) telescopically. Lying radially on the outside in an overlapping region, an outer steering column element 3 is provided. In the present case, the respective components are of rotationally symmetrical shape.

A sliding bush 4 made from a plastic material is arranged between the outer steering column element 3 and the inner steering column element 2. The inner steering column element 2 can be displaced in the sliding bush 4 in an axially slidable manner.

The sliding bush 4 itself is connected fixedly to the outer steering column element 3. For this purpose, the sliding bush 4 has two depressions 5 on its circumferential face which lies radially on the outside, which two depressions 5 are provided spaced apart from one another at the two ends of the sliding bush 4.

The depressions 5 form cavities or pockets 6 opposite the outer steering column element 3 which lies on the outside. The pockets 6 or depressions 5 of the sliding bush 4 are filled with plastic mass, possibly by injection molding, from the outside through the outer steering column element 3, with the result that a fixed connection can be formed between these components.

FIG. 2 shows a perspective view of the sliding bush 4 according to the invention.

The sliding bush 4 has a slot 7 over its entire length. The depressions 5 which then form the pockets 6 with the outer steering column element 3 are provided at both ends and extend on both sides of the slot 7 as far as the latter. When the plastic is filled in in the assembled state of the vehicle steering column, the depressions 5 are filled completely, with the result that manufacturing tolerances are eliminated between the sliding bush 4 and the outer steering column element 3. Here, the slot 7 is pushed together. A fixed connection is thus produced between the sliding bush 4 and the outer steering column element 3, and a connection is produced between the sliding bush 4 and the inner steering column element 2, which connection permits the inner steering column element 2 to slide in the bush 4. For this purpose, the sliding bush 4 can be manufactured from a material with sliding properties (for example, plastic). All tolerances between the outer steering column element 3 and the sliding bush 4 are eliminated by the solution according to the invention. The inner steering column element 2 can be displaced in the sliding bush 4 with minimum play and low forces.

Reinforcing ribs 8 are provided between the depressions 5 in order to increase the rigidity of the sliding bush 4. The solution according to the invention affords the advantage that the two steering column elements 2, 3 do not have to be machined mechanically and no locating fit has to be produced. The injection pockets lie apart from one another as far as possible, in order to maximize the supporting levers.

1-4. (canceled)

5. A vehicle steering column, comprising:
an inner steering column element which accommodates a steering spindle such that it can be displaced,
an outer steering column element which is arranged radially around the inner steering column element, and
a sliding bush, which bears slidably against the inner steering column element and is connected captively to the outer steering column element, by which it is possible for the inner steering column element and the outer steering column element to be displaced with respect to one another,
wherein pocketlike depressions run radially around the outer surface of the sliding bush and, in the mounted state of the vehicle steering column, are filled with plastic by injection molding through openings provided in the outer steering column element so as to form a fixed connection between the outer steering column element and the sliding bush with simultaneous closing of the openings,
wherein each pocketlike depression is arranged on the outside at axial ends of the sliding bush,
wherein the sliding bush has reinforcing ribs between the depressions, and
wherein the sliding bush bears slidably against the inner steering column element under a prestress.

6. The vehicle steering column as claimed in claim 5, wherein the sliding bush has a slot extending longitudinally, and wherein the depressions extend circumferentially toward both sides of the slot.

7. The vehicle steering column as claimed in claim 5, wherein the sliding bush is manufactured from a plastic having a low friction value.

8. The vehicle steering column as claimed in claim 5, wherein the inner steering column element, the outer steering column element, and the sliding bush are of cylindrical or triangular configurations.

9. The vehicle steering column as claimed in claim 6, wherein the sliding bush is manufactured from a plastic having a low friction value.

10. The vehicle steering column as claimed in claim 6, wherein the inner steering column element, the outer steering column element, and the sliding bush are of cylindrical or triangular configurations.

11. The vehicle steering column as claimed in claim 7, wherein the inner steering column element, the outer steering column element, and the sliding bush are of cylindrical or triangular configurations.
